(19) United States
(12) Patent Application Publication
(10) Pub. No.: US 2018/0239729 A1
(43) Pub. Date: Aug. 23, 2018

(54) INCREASING MEDIA AGNOSTIC UNIVERSAL SERIAL BUS (MA USB) THROUGHPUT USING MULTIPLE PARALLEL TCP CONNECTIONS

(71) Applicant: INTEL CORPORATION, Santa Clara, CA (US)

(72) Inventor: Bhalla Himanshu, Bengaluru (IN)

(73) Assignee: INTEL CORPORATION, Santa Clara, CA (US)

(21) Appl. No.: 15/437,151

(22) Filed: Feb. 20, 2017

(51) Int. Cl. G06F 13/38; G06F 13/42; H04L 29/06; H04L 29/08

(52) U.S. Cl. CPC G06F 13/385; G06F 13/4282; H04L 29/06517; H04L 29/08; H04L 65/608; H04L 29/06027

(57) ABSTRACT

Techniques for Media Agnostic Universal Serial Bus (MA USB) communication are described. An example apparatus includes a memory and processing circuitry coupled to the memory. The processing circuitry is configured to receive a data transfer request from an application running on the processor to transmit data to an electronic device. In response to the data transfer request, the processing circuitry sets up a traffic stream between the apparatus and the electronic device. The traffic stream comprises a plurality of Transmission Control Protocol (TCP) connections

### TECHNICAL FIELD

This disclosure relates generally to techniques for managing a Universal Serial Bus (USB) link. More specifically, the disclosure describes techniques for increasing throughput of a Media Agnostic USB (MA USB) link using multiple parallel TCP connections.

### BACKGROUND

Media Agnostic USB (MA USB) communication between host and device for non-isochronous end-points relies on the Transmission Control Protocol (TCP) protocol for encapsulating and transferring data. MA USB throughput for use-cases like mass-storage is limited by the throughput provided by the underlying TCP implementation. This problem is known in networking terminology as Bandwidth Delay Product.

### BRIEF DESCRIPTION OF DRAWINGS

FIG. 1 is a block diagram of an example MA USB system.

FIGS. 2A, 2B, and 2C are a diagram illustrating data flow between an MA USB device and an MA USB host for establishing a multiple parallel TCP connections for a specific non-isochronous traffic stream.

FIG. 3 is a block diagram illustrating a method of transmitting from an MA USB transmitter (Tx) to an MA USB receiver (Rx) using multiple parallel TCP connections for a specific non-isochronous traffic stream.

FIGS. 4A-G illustrate a process for sequencing the received out-of-order packets from multiple TCP threads and connections.

FIG. 5 is a block diagram of an example computing device configured to use the MA USB protocol with multiple parallel TCP connections.

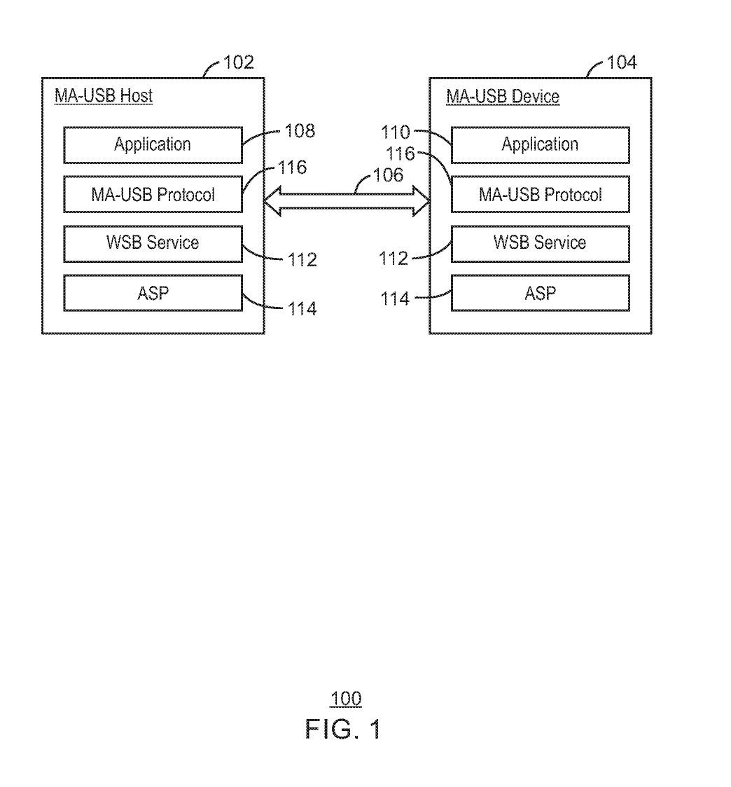

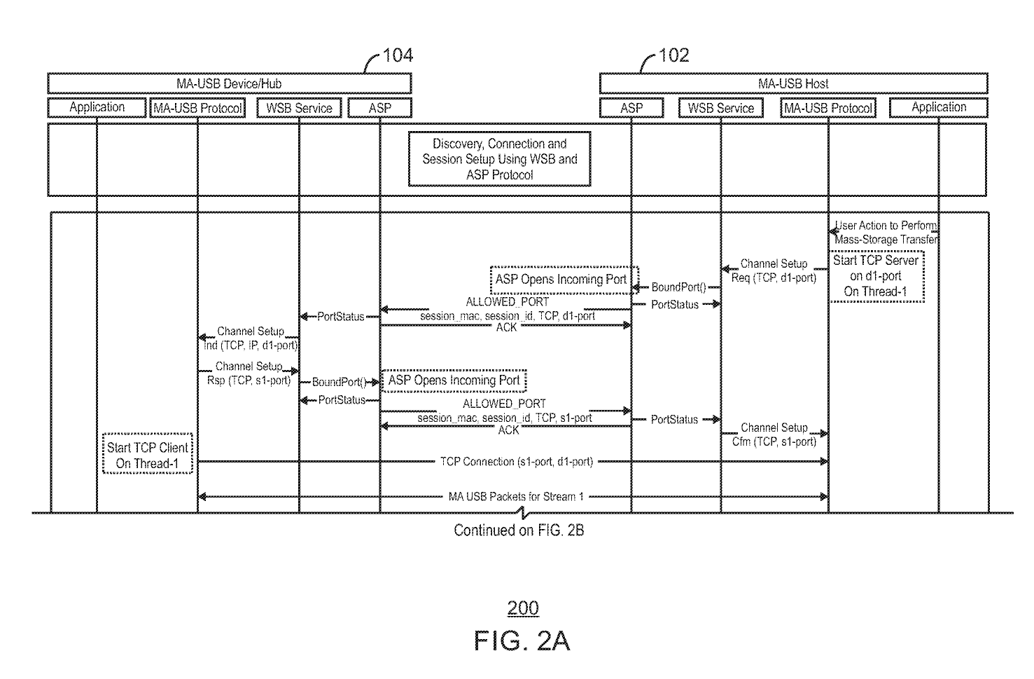

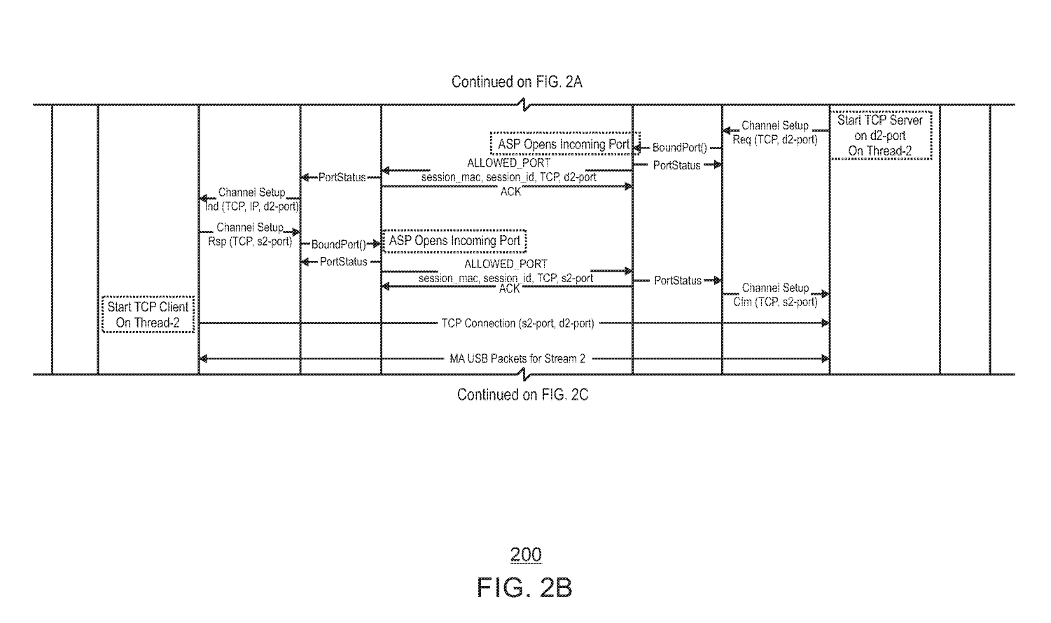

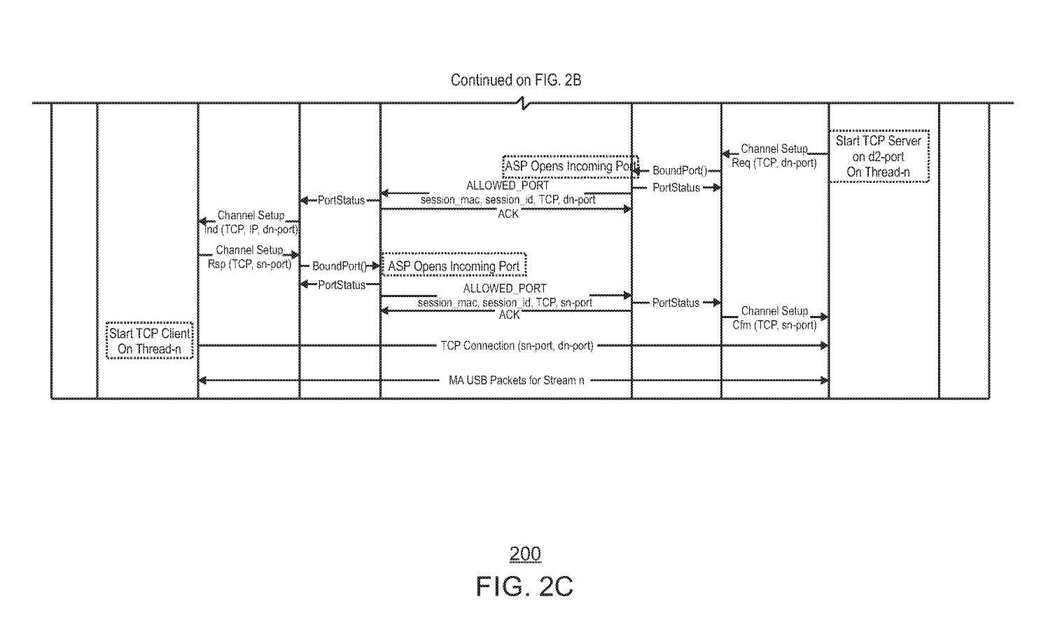

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

The subject matter disclosed herein relates to techniques for managing an MA USB link. More specifically, the present disclosure describes techniques to increase the MA USB throughput by using multiple parallel TCP connections. Since TCP is a connection-oriented and reliable protocol which requires acknowledgments there is some overhead involved in data communication due to inherent Nagle's algorithm and delayed-Ack method. There are solutions like TCP Quick-Ack, which attempts to address this problem. But not all platforms support Quick-Ack and therefore the MA USB protocol relies on the Operating System's implementation of TCP. Also, these methods attempt to optimize a single TCP connection but do not take advantage of the system as a whole.

There are some solutions that attempt to use UDP for increasing throughput. But these solutions are only applicable for single-hop MAC-layer-reliable connections. By contrast, the techniques disclosed herein work on both single-hop and multiple-hop connections and reliability is handled by the TCP protocol itself.

To support multiple parallel TCP connections for a single non-isochronous data stream, the MA USB specification is enhanced to support the spawning of multiple threads, with each thread establishing a separate TCP connection with the peer. These threads can utilize the multi-core architecture of the platform and also the MIMO (Multiple-Input-Multiple-Output) feature of Wireless Network Interface Controllers (NICs). The MA USB specification is also enhanced to provide mechanisms for segmentation and reassembly. In this way, the MA USB layer does not rely on the underlying TCP implementation, but rather uses the parallelization provided by the operating system, platform, and wireless hardware and software for better throughput.

The present disclosure describes techniques for using multiple parallel TCP connections to increase MA USB throughput for a single non-isochronous data stream. Multiple parallel TCP connections use the available bandwidth more efficiently and hence provide better throughput than a single TCP connection. There may be some overhead involved in segmentation and reassembly, i.e., splitting the packets at source and sending them over different TCP connections and then reassembling them at the sink. However, the overhead will be insignificant compared to the increase in throughput achieved.

In accordance with the disclosed techniques, the MA USB layer intelligently uses multiple TCP connections for better throughput. The disclosed techniques also enable the use of multi-core architectures for providing efficient multi-threading, and the Multiple Input Multiple Output (MIMO) feature of wireless Network Interface Controllers (NICs) for better bandwidth utilization.

Some communications protocols, such as User Datagram Protocol (UDP), use single hop MAC layer reliable connections. For use cases like mass storage where the user wants to wirelessly copy data between a flash drive and a personal computer reliability of data is important. However, the UDP protocol cannot provide a suitable level of reliability, especially for multi-hop links. The TCP protocol is able to provide a high level of reliability for multiple-hop connections. The invention expands the use of TCP by introducing multi-threading and multi-TCP-channel establishment for better bandwidth utilization and higher throughput.

FIG. 1 is a block diagram of an example MA USB system. The example MA USB system includes a host 102 and a device 104 in communication with each other through a traffic stream 106. The host 102 and device 104 may be any combination of components capable of communicating through the MA USB protocol. For example, the host 102 may be a general purpose computing device such as a personal computer, smartphone, tablet computer, laptop, smart television, and others. The device 104 may be another general purpose computing device or a peripheral device such as a mass storage device, flash drive, printer, pointing device, keyboard, a display device, and others. The device 104 may also be a hub.

The traffic stream 106 may be implemented over any suitable communication medium, including a wired connection, a wireless connection such as WiFi, a Local Area Network (LAN), the Internet, a cellular network, and others, including combinations thereof. As described further below, the traffic stream 106 may be implemented as one or more TCP connections. Additionally, the traffic stream 106 may be implemented over a multiple hop network connection. The traffic stream 106 may also be implemented over a direct connection between the host 102 and the device 104, such as a WiFi Direct connection, which enables two devices to communicate with each other without a wireless access point.

The traffic stream 106 carries information between a host application 108 and a device application 110. The host 102 and device 104 implement a number of protocol services to implement the MA USB traffic stream 106. Specifically, the host 102 and device 104 provide a WSB service 112, Application Service Platform (ASP) 114, and an MA USB protocol module 116. The WSB Service 112 may be deployed as a service over the Wi-Fi Direct Services (WFDS) Application Service Platform (ASP). The WSB Service 112 performs device and service discovery to enable the host 102 and device 104 to discover one another and discover each other's service attributes. The service attributes may include parameters such as service name, protocol used, service specific information, and others. After device and service discovery, the host 102 and device 104 can connect to each other by setting up a communication session through the ASP 114. After the communication session is established, the MA USB protocol module 116 is used to perform USB device enumeration and USB data transfers.

The data transfer may be non-isochronous transfers such as Interrupt transfers, and bulk data transfers. An interrupt transfer is a type of transfer in which the device relies on a bounded latency to ensure quick responses. Interrupt transfers may be used, for example, to transfer data associated with user input devices such as keyboard or pointers. Bulk transfers are transfers are sporadic transfers of large amounts of data with no guarantee of a specific bandwidth or latency. Examples of bulk transfers include file transfers such as file transfers between a PC and a flash drive. An isochronous transfer refers to a data transfer that uses some guaranteed data rate but with possible data loss. For example, an isochronous data transfer includes the transfer of real-time video or audio data.

The WSB service 112, ASP 114, and MA USB protocol module 116 may be implemented in hardware or a combination of hardware and software or hardware and firmware. In some embodiments, the WSB service 112, ASP 114, and MA USB protocol module 116 may be implemented in a single Integrated Circuit (IC) package. An example process for establishing an MA USB communication session is described further below in relations to FIGS. 2A-2C.

FIGS. 2A, 2B, and 2C are a diagram illustrating data flow between an MA USB device and an MA USB host for establishing a multiple parallel TCP connections for a specific non-isochronous traffic stream. The data flow 200 is one example of a data flow that may be used to establish an MA USB traffic stream that includes multiple parallel TCP connections.

First, discovery, connection, and session setup are performed using the WSB service and ASP protocol. Once the WSB session is established, the MA USB service is activated and is able to receive user actions from the application. The application may be executing on a multi-core processor. Upon receipt of a user action to perform a data transfer, the MA USB service starts a TCP server on d1-port on thread-1. The MA USB then sends a channel setup request to the WSB service to setup a TCP channel on the d1-port. The WSB service then issues a BoundPort( ) command to the ASP, the ASP opens an incoming port, and send a PortStatus message to the WSB service.

Next, the host ASP sends an Allowed_Port message to the device ASP and receives an acknowledgement from the device ASP confirming that the message was received. The Allowed_Port message sent to the device enables the device to establish a TCP connection to the host through the port identified by the Allowed_Port message.

After receiving the ALLOWED_PORT message from the Host ASP, the Device ASP initiates a TCP connection to the allowed TCP port on the host. To initiate the TCP connection to the allowed TCP port, the device ASP sends a PortStatus message to the device WSB service. The device WSB service sends a Channel Setup message to the device MA USB protocol module and receives a Channel Setup response. The device WSB service then issues a BoundPort( ) message to the device ASP, the ASP opens an incoming port, and send a PortStatus message to the device WSB service.

The device ASP then sends a corresponding ALLOWED_PORT message to the host ASP with the opened incoming TCP port of the device. In response to the ALLOWED_PORT message from the device ASP, the host ASP initiates a TCP connection to the allowed TCP port on the host. To initiate the TCP connection to the allowed TCP port, the host ASP sends a PortStatus message to the host WSB service. The host WSB service sends a Channel Setup message to the device MA USB protocol module. The device MA USB protocol module then starts a TCP on thread 1. At this point, the first TCP connection is established between the host MA USB protocol module and the device MA USB protocol module. This first TCP connection serves as a communication link for the MA USB protocol between the host and the device. Once the TCP connection is established, the host MA USB protocol module can begin sending packets to the device MA USB protocol module.

The process flow illustrated in FIG. 2A is repeated to establish a second TCP connection associated with a second thread, as shown FIG. 2B. The process flow illustrated in FIG. 2A may be repeated any suitable number of times to generate additional TCP connections, each associated with a different thread. Each thread may be running on a different core of a multi-core processor. FIG. 2C shows the process flow for establishing the nth TCP connection associated with the nth thread.

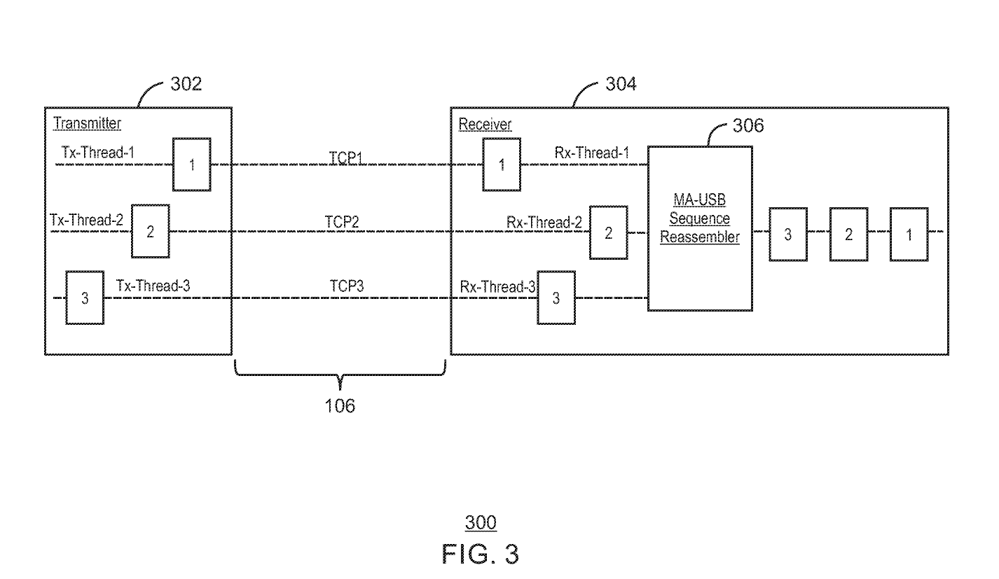

FIG. 3 is a block diagram illustrating a method of transmitting packets from an MA USB transmitter (Tx) to an MA USB receiver (Rx) using multiple parallel TCP connections for a specific non-isochronous traffic stream. With reference to FIG. 1, the transmitter 302 may be included in the host 102 while the receiver 304 may be included in the device 104, or vice-versa. It most cases, the host 102 and the device 104 will have both a transmitter and a receiver to allow for two-way communication.

The traffic stream 106 in this example includes three parallel TCP connections for transferring packets to the receiver 304. However, in an actual implementation the traffic stream 106 may include any suitable number of TCP connections. The TCP connections may be established as described above in relation to FIGS. 2A-C.

In this example, the MA USB packet queue on the transmitter 302 is read concurrently by multiple threads (Tx-Thread-1, Tx-Thread-2, and Tx-Thread-3) each thread having a separate TCP connection with the receiver 302. Each thread may be running in a separate core and can be scheduled based on the OS scheduling policy.

In some cases, a host 102 and device 104 may be configured to open two or more independent traffic streams. For example, two separate and unrelated applications residing on the host may receive data packets from corresponding applications on the device. In the case of independent traffic streams, the data packets are not interrelated or dependent on one another. Therefore, the relative ordering of the packets in unimportant. In the example shown in FIG. 3, the TCP connections form a single traffic stream, meaning that the packets are related to the same flow of data between an application on the host and a corresponding application on the device. Accordingly, packets received by an application should be consumed in the same order that they are generated.

As shown in FIG. 3, a number of packets, labeled 1, 2, and 3, are being sent from the transmitter 302 to the receiver 304. Each of these MA USB packets are independently sent by the individual threads on a separate TCP connections (TCP1. TCP2, and TCP3). Since the receiver is aware of these three TCP connections using the WSB protocol, the receiver spawns its own corresponding set of threads (Rx-Thread-1, Rx-Thread-2, and Rx-Thread-3) as shown in FIG. 3. The packets are sent in the order in which they are generated. And each packet is acknowledged by the receiver using a parallel acknowledgments for each TCP connection.

Note that this multi-threading method can be applicable on a single TCP connection as well. In that case, the receiver has no way to determine how many threads the transmitter is using, and the receiver cannot take advantage of multi-threading at its end. Thus, for a single TCP connection, the receiver is configured to provide serialized acknowledgements instead of multiple parallel acknowledgments. Serialized acknowledgements may eventually lead to delay at the transmitter side.

In some embodiments, if the transmit and receive devices support both WiFi and cellular interfaces and there is a connection between the two, then it is possible to perform aggregation over both these physical mediums by some TCP connections established over Wi-Fi and some TCP connections over cellular (or ProSe-direct).

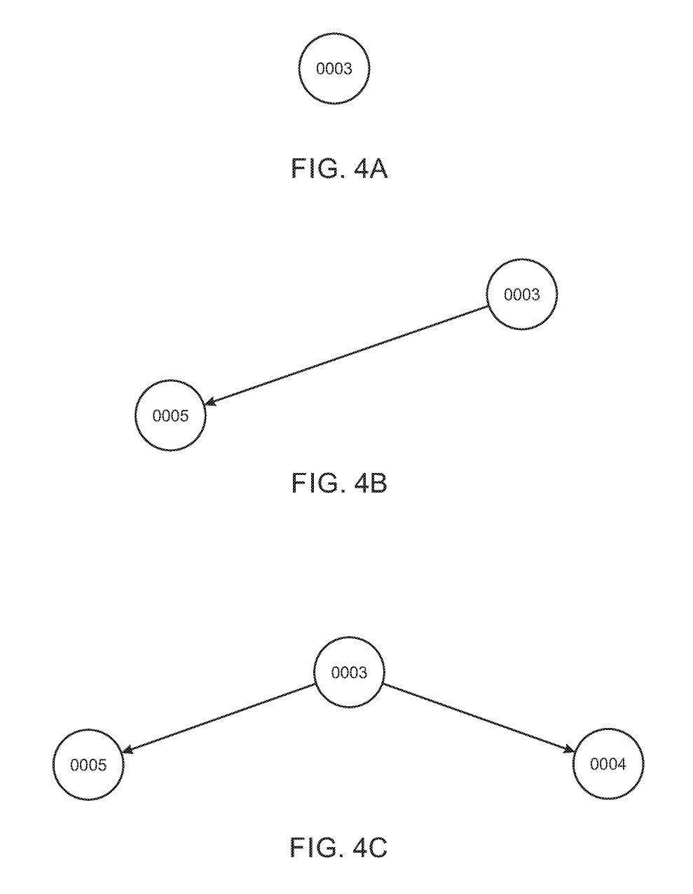

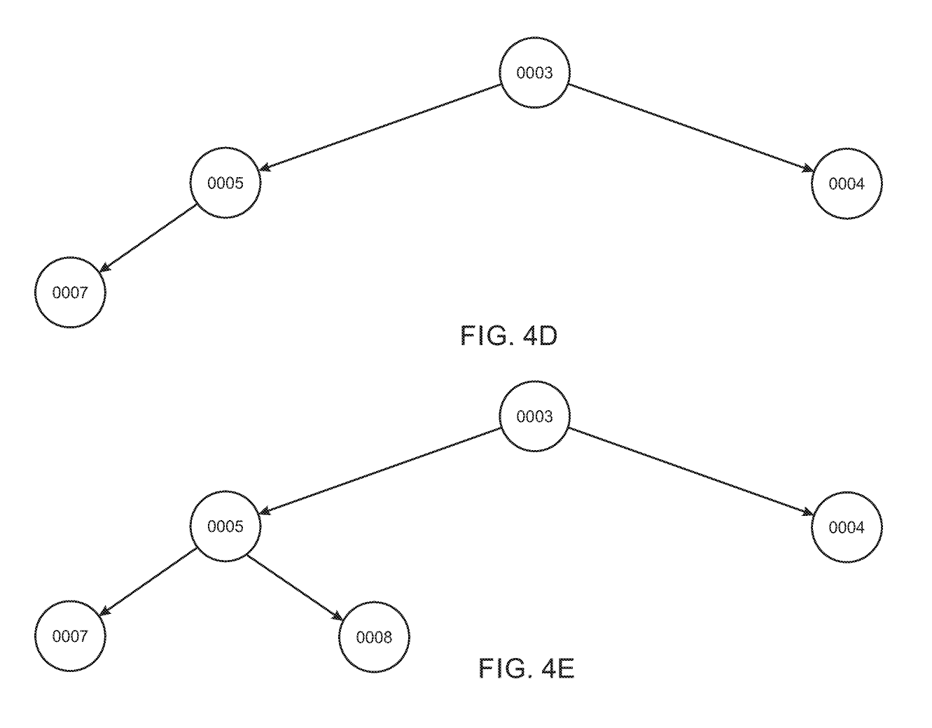

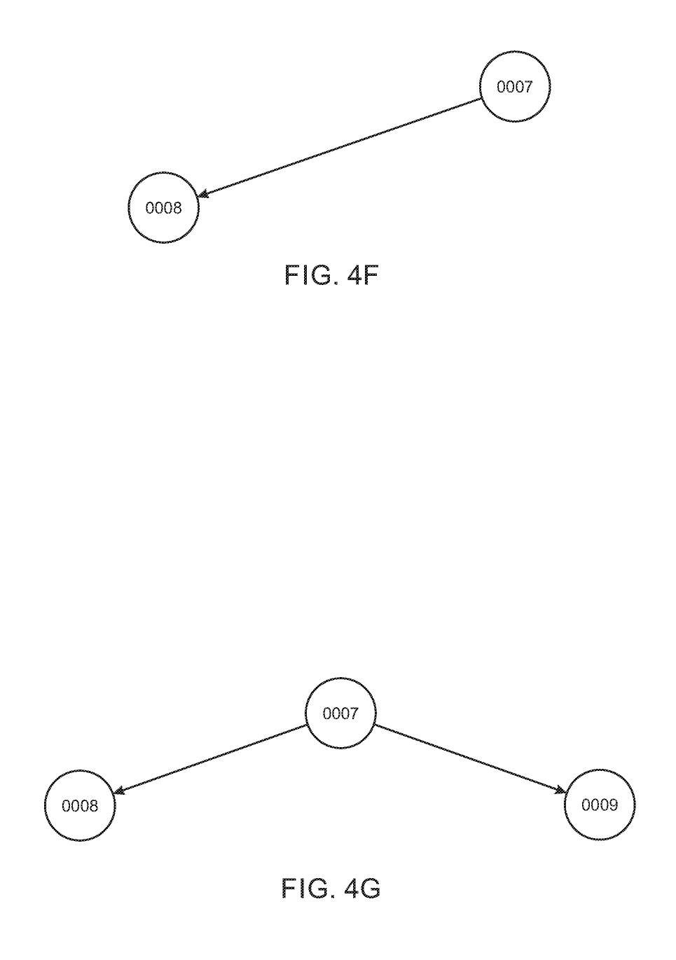

Due to the possibly different travel times for each TCP connection, the packets may arrive at the receiver out of order. Each packet may include a sequence number that identifies the packet order. As shown in FIG. 3, the packets are transmitted in order, with packet 1 being transmitted first, packet 2 being transmitted second, and packet three being transmitted last. However, at the receiver packet 2 is received first, packet three is received second, and packet 1 is received last. To reassemble the packets in the correct order, the receiver 304 includes an MA USB sequence reassembler 306. The MA USB sequence reassembler 306 may be implemented by the MA USB protocol module. An example sequence reassembly process is described further in relation to FIGS. 4A-4G.

FIGS. 4A-G illustrate a process for sequencing the received out-of-order packets from multiple TCP threads and connections. The sequencing process may reorder packets using sequence numbers that identify successive data packets. For example, sequence number may be the sequence number defined in section 6.5.1.4 the MA USB specification.

Additionally, the sequencing process may use a Heap data structure of the sequence numbers, including a Min-heap data structure, a Fibonacci Heap, and others. The Min-Heap data structure is a binary tree wherein the value of each node is greater than or equal to the value of its parent, with the minimum-value element at the root. Using a Min-Heap data structure, the runtime of both the deleteMin( ) and insert( ) operations, as expressed in “Big O” notation, is O(log n), where n equals the number of out of order packets. Using a Fibonacci Heap data structure, the runtime of deleteMin( ) as expressed in “Big O” notation is O(log n) and the runtime of insert( ) is O(1).

TABLE
Process variables and methods:

| | | |
|---|---|---|
| Variable: | Arrived_Sequence_Number | Sequence Number of the Arrived MA |
| | | USB packet from any of the n TCP |
| | | threads. |
| Variable: | Current_Sequence_Number | To maintain the order of MA USB |
| | | packets (Initialized to 0) |
| Method: | Min_Heap.root( ) | To get minimum Sequence Number |
| | | of the Min-Heap (without deleting it). |
| | | This is constant O(1) time operation. |
| Method: | Min_Heap.insert(Seq_Num) | To insert a Sequence Number into |
| | | the Min-Heap. This is O(log n) time |
| | | operation. |
| Method: | Seq_Num Min_Heap.deleteMin( ) | To delete and return the root of the |
| | | Min-Heap and then Heapify( ) the Min- |
| | | Heap. This is O(log n) time |
| | | operation. |

As shown in the following process, any time a packet is received in the proper order, the packet is forwarded to the application and consumed. If a packet is received out of order, the packet is added to the min-heap data structure. Once the missing packet or packets arrive at the receiver, those packets are forwarded and consumed. Any waiting packets that were added to the heap may be removed from the heap and forwarded as soon as the earlier missing packets are received and forwarded.

The following pseudo code describes an example of a sequencing process that may occur when a packet arrives at the receiver from any of the n threads.

Current_Sequence_Number = 0;
Arrived_Sequence_Number starts from 1
If (Current_Sequence_Number + 1 == Arrived_Sequence_Number)
{

Current_Sequence_Number = Current_Sequence_Number + 1;
Send the arrived packet to the application;
while (Min_Heap.root( ) == Current_Sequence_Number)
{

Current_Sequence_Number = Current_Sequence_Number +
1 ; Seq_Num = Min_Heap.deleteMin( );
Send the stored packet with this Seq_Num to the application;

}

}
Else
{

Min.Heap.insert(Arrived_Sequence_Number);

}

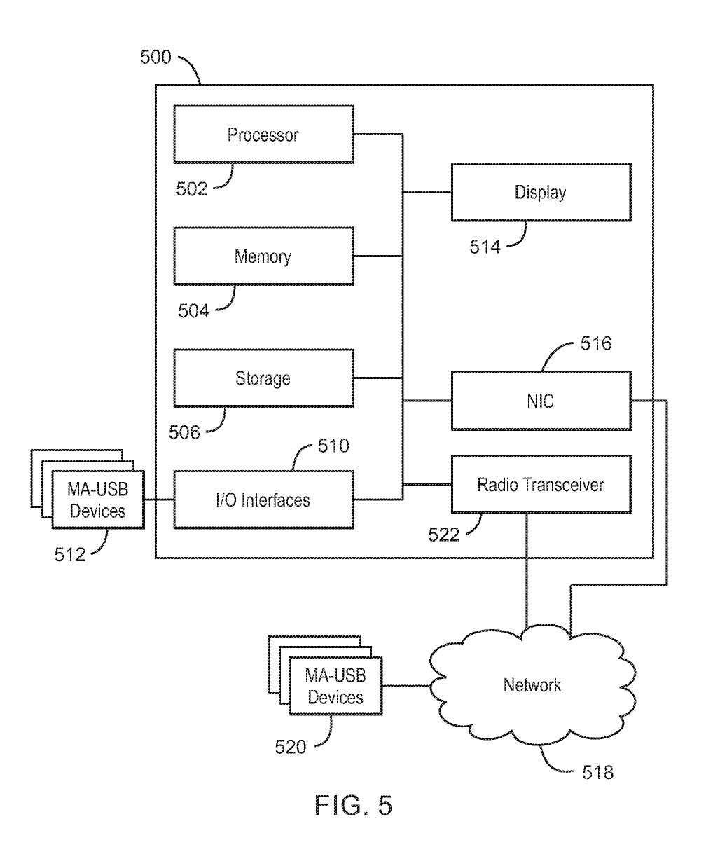

The example shown in FIGS. 4A-5G describes the sequencing process for ten MA USB packets arriving at the receiver with the following sequence numbers: 3, 5, 1, 4, 7, 8, 2, 9, 6, 10. At the start of the process, the current sequence number is 0 (no packets have been received). The first packet received has the sequence number 3 (Arrived_Sequence_Number =3; Current_Sequence_Number=0). As a result, the packet with sequence number 3 is added to the Min_Heap data structure, as shown in FIG. 4A.

The next packet received has the sequence number 5 (Arrived_Sequence_Number=5; Current_Sequence_Number=0). As a result, the packet with sequence number 5 is added to the Min_Heap data structure, as shown in FIG. 4B.

The next packet received has the sequence number 1 (Arrived_Sequence_Number=1; Current_Sequence_Number=0). As a result, the packet with sequence number 1 is sent to the application, the current sequence number is incremented (Current_Sequence_Number=Current_Sequence_Number+1), and the Min_Heap data structure does not change (remains as shown in FIG. 4B).

The next packet received has the sequence number 4 (Arrived_Sequence_Number=4; Current_Sequence_Number=1). As a result, the packet with sequence number 4 is added to the Min_Heap data structure, as shown in FIG. 4C.

The next packet received has the sequence number 7 (Arrived_Sequence_Number=7; Current_Sequence_Number=1). As a result, the packet with sequence number 7 is added to the Min_Heap data structure, as shown in FIG. 4D.

The next packet received has the sequence number 8 (Arrived_Sequence_Number=8; Current_Sequence_Number=1). As a result, the packet with sequence number 8 is added to the Min_Heap data structure, as shown in FIG. 4E.

The next packet received has the sequence number 2 (Arrived_Sequence_Number=2; Current_Sequence_Number=1). As a result, the packet with sequence number 2 is sent to the application. Additionally, the packets with sequence numbers 3, 4, and 5 are removed from the Min_Heap data structure and sent to the application in order. The current sequence number is incremented each rime another data packet is sent to the application. FIG. 4F represents the Min_Heap data structure after the packets with sequence numbers 3, 4, and 5 are removed.

The next packet received has the sequence number 9 (Arrived_Sequence_Number=9; Current_Sequence_Number=5). As a result, the packet with sequence number 9 is added to the Min_Heap data structure, as shown in FIG. 4G.

The next packet received has the sequence number 6 (Arrived_Sequence_Number=6; Current_Sequence_Number=5). As a result, the packet with sequence number 6 is sent to the application. Additionally, the packets with sequence numbers 7, 8, and 9 are removed from the Min_Heap data structure and sent to the application in order. The current sequence number is incremented each time another data packet is sent to the application. At this time, the Min_Heap data structure is empty.

The next packet received has the sequence number 10 (Arrived_Sequence_Number=10; Current_Sequence_Number=9). As a result, the packet with sequence number 10 is sent to the application, and the current sequence number is incremented. At this time, the Min_Heap data structure is empty. Therefore no additional data packets are ready to be sent to the application.

The process described above can re-order the out of order MA USB packets with a high level of storage space efficiency and fast processing time. The techniques described herein can be used to increase the throughput of MA USB over both Peer-to-Peer or AP linked wireless links and therefore will have a significant impact on the success of MA USB, especially for mass storage applications. The disclosed techniques are provide the ability to use a multi-core architectures and the MIMO feature of the WiFi Network Interface Controllers (NICs). Although this method enables re-ordering for multiple TCP connections, it can also be used for re-ordering MA-USB packets that arrive over UDP connections as well, since UDP by design may have out-of-order packets.

FIG. 5 is a block diagram of an example computing device configured to use the MA USB protocol with multiple parallel TCP connections. The computing device 500 may be any type of computing device such as a personal computer, smartphone, tablet computer, laptop, smart television, and others. The computing device 500 may include a processor 502 that is configured to execute stored instructions, as well as a memory device 504 that stores instructions that are executable by the processor 502. The processor 502 may be coupled to the memory device 504 by a bus 506. The processor 502 may be a single core processor, a multi-core processor, a computing cluster, or any number of other configurations. The processor 502 may be implemented as a Complex Instruction Set Computer (CISC) processor, a Reduced Instruction Set Computer (RISC) processor, x86 Instruction set compatible processor, or any other microprocessor or central processing unit (CPU). In some embodiments, the processor 502 includes dual-core processor(s), dual-core mobile processor(s), or the like.

The memory device 504 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM. EPROM, EEPROM. etc.), flash memory, or any other suitable memory system. The memory device 504 can be used to store data and computer-readable instructions that, when executed by the CPU processor, direct the processor 502 to perform various operations in accordance with embodiments described herein.

The computing device 500 may also include a storage device 506. The storage device 506 is a physical memory device such as a flash drive or an array of flash drives, or any combinations thereof. The storage device 506 may store programming code such as device drivers, software applications, operating systems, and the like. The programming code stored by the storage device 506 may be executed by the processor 502.

The computing device 500 may also include an input/output (I/O) interfaces 510 configured to connect the computing device 500 to one or more MA USB devices 512. For example, the MA USB devices 512 may include any type of peripheral device such as user input devices, a printer, a scanner, a keyboard, and a pointing device such as a mouse, touchpad, or, touchscreen, a display, an external data storage device, among others. The I/O interfaces 510 may also include one or more interfaces for communicating with a computing device, such as a computer, tablet or smart phone. The I/O interfaces may include wired or wireless interfaces, including Universal Serial Bus (USB), High-Definition Multimedia Interface (HDMI). Bluetooth, WiFi, PCI Express (Peripheral Component Interconnect Express), and others.

The computing device 500 also includes a display 514, which may be a built-in display or externally coupled. The computing device 500 may also include a network interface controller (NIC) 516 configured to connect the computing device 100 through to a network 518. The network 518 may be a wide area network (WAN), local area network (LAN), a cellular network, or the Internet, among others. Through the network 518, the computing device 500 may couple to additional MA USB devices 520. The MA USB devices 520 can include any suitable electronic devices, including computing devices similar to the computing device 500, remote servers, network printers, and others.

The computing device 500 can also include a radio transceiver 522, for communications with the network 518. The radio transceiver 5122 may include any number of frequencies and protocols, such as a WLAN unit used to implement Wi-Fi™ communications in accordance with the Institute of Electrical and Electronics Engineers (IEEE) 802.11 standard. In addition, wireless wide area communications. e.g., according to a cellular or other wireless wide area protocol, may be implemented via a WWAN unit. The radio transceiver may also be configured to implement a Multiple Input Multiple Output (MIMO) communication standard, including WiFi standards such as IEEE 802.11n (Wi-Fi), IEEE 802.11ac (Wi-Fi) and cellular communication standards such as WiMAX, Long Term Evolution (LTE), 5G, and others. MIMO is a technique for enabling wireless communications over multiple transmit and receive antennas, such that each antenna transmits and/or receives a different data signal. In embodiments wherein the radio transceiver implements MIMO capabilities, each TCP connection generated by the MA USB protocol module may be tied to a particular antenna. Any number of other radios, configured for a particular wireless communication protocol, may be included in the radio transceiver 910.

The computing device 500 and the MA USB devices are configured to enable MA USB communication over wired and/or wireless connections as described above. With reference to FIG. 1, the MA USB protocol module 116, the WSB service 112, and the ASP 114 may be implemented by any suitable combination of hardware components of the computing device 500. For example, the MA USB protocol module 116, the WSB service 112, and the ASP 114 may be implemented in the processor 502, the I/O interface 510, the NIC 516, and/or the radio transceiver 516. In some examples, the MA USB protocol module 116, the WSB service 112, and the ASP 114 may be included in a single communication microcontroller.

The block diagram of FIG. 5 is not intended to indicate that the computing device 500 is to include all of the components shown in FIG. 5. Rather, the computing system 500 can include fewer or additional components not shown in FIG. 5, depending on the details of the specific implementation. For example, the functionality may be implemented in any combination of Application Specific Integrated Circuits (ASICs), Field Programmable Gate Arrays (FPGAs), logic circuits, and the like. In addition, components of the computing device can be implemented in ultra-compact form factor devices, such as System-On-a-Chip (SOC), and multi-chip modules.

### EXAMPLES

Example 1 is an apparatus configured for Media Agnostic Universal Serial Bus (MA USB) communication. The apparatus includes a memory and processing circuitry coupled to the memory. The processing circuitry is configured to receive a data transfer request from an application to transmit data to an electronic device. In response to the data transfer request, the processing circuitry is to establish an MA USB traffic stream between the apparatus and the electronic device. The MA USB traffic stream includes a plurality of Transmission Control Protocol (TCP) connections.

Example 2 includes the apparatus of example 1, including or excluding optional features. In this example, the application is running on a multi-core processor, and each TCP connection corresponds with a separate thread executed on a separate core of the multi-core processor.

Example 3 includes the apparatus of any one of examples 1 to 2, including or excluding optional features. In this example, the electronic device initiates a separate receiving thread for each of the TCP connections.

Example 4 includes the apparatus of any one of examples 1 to 3, including or excluding optional features. In this example, the apparatus includes an MA USB sequence reassembler to reorder MA USB packets received from the electronic device. Optionally, the MA USB sequence reassembler uses a min-heap data structure to temporarily store packets that are received out of order.

Example 5 includes the apparatus of any one of examples 1 to 4, including or excluding optional features. In this example, the processing circuitry receives parallel acknowledgements from the electronic device on each of the plurality of TCP connections.

Example 6 includes the apparatus of any one of examples 1 to 5, including or excluding optional features. In this example, the plurality of TCP connections include a first TCP connection and a second TCP connection, wherein the first TCP connection is established over a wired communication medium and the second TCP connection is established over a wireless communication medium.

Example 7 includes the apparatus of any one of examples 1 to 6, including or excluding optional features. In this example, the plurality of TCP connections include a first TCP connection and a second TCP connection, wherein the first TCP connection is established over a WiFi network and the second TCP connection is established over a cellular network.

Example 8 includes the apparatus of any one of examples 1 to 7, including or excluding optional features. In this example, the apparatus includes a Multiple Input Multiple Output (MIMO) radio transceiver, wherein each of the plurality of TCP connections is tied to a different antenna of the MIMO radio transceiver.

Example 9 includes the apparatus of any one of examples 1 to 8, including or excluding optional features. In this example, the electronic device is a wireless mass storage device.

Example 10 is an integrated circuit package including one or more processors configured to establish Media Agnostic Universal Serial Bus (MA USB) communication with an electronic device. The one or more processors receive a data transfer request from an application to transmit data to the electronic device. In response to the data transfer request, the one or more processors establish an MA USB traffic stream between the processor and the electronic device. The MA USB traffic stream includes a plurality of Transmission Control Protocol (TCP) connections.

Example 11 includes the integrated circuit package of example 10, including or excluding optional features. In this example, the application is executing on a multi-core processor, and each TCP connection corresponds with a separate thread executed on a separate core of the multi-core processor.

Example 12 includes the integrated circuit package of any one of examples 10 to 11, including or excluding optional features. In this example, the electronic device initiates a separate receiving thread for each of the TCP connections.

Example 13 includes the integrated circuit package of any one of examples 10 to 12, including or excluding optional features. In this example, the integrated circuit package includes an MA USB sequence reassembler to reorder MA USB packets received from the electronic device. Optionally, the MA USB sequence reassembler uses a min-heap data structure to temporarily store packets that are received out of order.

Example 14 includes the integrated circuit package of any one of examples 10 to 13, including or excluding optional features. In this example, the integrated circuit package receives parallel acknowledgements from the electronic device on each of the plurality of TCP connections.

Example 15 includes the integrated circuit package of any one of examples 10 to 14, including or excluding optional features. In this example, the plurality of TCP connections include a first TCP connection and a second TCP connection, wherein the first TCP connection is established over a wired communication medium and the second TCP connection is established over a wireless communication medium.

Example 16 includes the integrated circuit package of any one of examples 10 to 15, including or excluding optional features. In this example, the plurality of TCP connections include a first TCP connection and a second TCP connection, wherein the first TCP connection is established over a WiFi network and the second TCP connection is established over a cellular network.

Example 17 includes the integrated circuit package of any one of examples 10 to 16, including or excluding optional features. In this example, each of the plurality of TCP connections is tied to a different antenna of a MIMO radio transceiver.

Example 18 includes the integrated circuit package of any one of examples 10 to 17, including or excluding optional features. In this example, the electronic device is a wireless mass storage device.

Example 19 is a method of establishing Media Agnostic Universal Serial Bus (MA USB) communication with an electronic device. The method includes receiving a data transfer request from an application to transmit data to the electronic device; and in response to the data transfer request, establishing an MA USB traffic stream to the electronic device. The MA USB traffic stream includes a plurality of Transmission Control Protocol (TCP) connections.

Example 20 includes the method of example 19, including or excluding optional features. In this example, the application is executing on a multi-core processor, and the method includes associating each TCP connection with a separate thread being executed on a separate core of the multi-core processor.

Example 21 includes the method of any one of examples 19 to 20, including or excluding optional features. In this example, the electronic device initiates a separate receiving thread for each of the TCP connections.

Example 22 includes the method of any one of examples 19 to 21, including or excluding optional features. In this example, the method includes reordering MA USB packets received from the electronic device.

Example 23 includes the method of any one of examples 19 to 22, including or excluding optional features. In this example, the method includes temporarily storing packets that are received out of order to a min-heap data structure.

Example 24 includes the method of any one of examples 19 to 23, including or excluding optional features. In this example, the method includes receiving parallel acknowledgements from the electronic device on each of the plurality of TCP connections.

Example 25 includes the method of any one of examples 19 to 24, including or excluding optional features. In this example, the plurality of TCP connections include a first TCP connection and a second TCP connection, and the method includes establishing the first TCP connection over a wired communication medium and establishing the second TCP connection over a wireless communication medium.

Example 26 includes the method of any one of examples 19 to 25, including or excluding optional features. In this example, the plurality of TCP connections include a first TCP connection and a second TCP connection, and the method includes establishing the first TCP connection over a WiFi network and establishing the second TCP connection over a cellular network.

Example 27 includes the method of any one of examples 19 to 26, including or excluding optional features. In this example, each of the plurality of TCP connections is tied to a different antenna of a MIMO radio transceiver.

Example 28 includes the method of any one of examples 19 to 27, including or excluding optional features. In this example, the electronic device is a wireless mass storage device.

Example 29 is a tangible, non-transitory, computer-readable medium including instructions that, when executed by a processor, direct the processor to establish Media Agnostic Universal Serial Bus (MA USB) communication with an electronic device. The computer-readable medium includes instructions that direct the processor to receive a data transfer request to transmit data to the electronic device; and in response to the data transfer request, establish an MA USB traffic stream between the processor and the electronic device. The MA USB traffic stream includes a plurality of Transmission Control Protocol (TCP) connections.

Example 30 includes the computer-readable medium of example 29, including or excluding optional features. In this example, the data transfer request is received from an application executing on a multi-core processor, and each TCP connection corresponds with a separate thread executed on a separate core of the multi-core processor.

Example 31 includes the computer-readable medium of any one of examples 29 to 30, including or excluding optional features. In this example, the electronic device initiates a separate receiving thread for each of the TCP connections.

Example 32 includes the computer-readable medium of any one of examples 29 to 31, including or excluding optional features. In this example, the computer-readable medium includes instructions to direct the processor to reorder MA USB packets received from the electronic device. Optionally, the instructions to direct the processor to reorder MA USB packets include instructions to temporarily store packets that are received out of order to a min-heap data structure.

Example 33 includes the computer-readable medium of any one of examples 29 to 32, including or excluding optional features. In this example, the computer-readable medium includes instructions to direct the processor to receive parallel acknowledgements from the electronic device on each of the plurality of TCP connections.

Example 34 includes the computer-readable medium of any one of examples 29 to 33, including or excluding optional features. In this example, the plurality of TCP connections include a first TCP connection and a second TCP connection, and the computer-readable medium includes instructions to direct the processor to establish the first TCP connection over a wired communication medium and establish the second TCP connection over a wireless communication medium.

Example 35 includes the computer-readable medium of any one of examples 29 to 34, including or excluding optional features. In this example, the plurality of TCP connections include a first TCP connection and a second TCP connection, and the computer-readable medium includes instructions to direct the processor to establish the first TCP connection over a WiFi network and establish the second TCP connection over a cellular network.

Example 36 includes the computer-readable medium of any one of examples 29 to 35, including or excluding optional features. In this example, each of the plurality of TCP connections is tied to a different antenna of a MIMO radio transceiver.

Example 37 includes the computer-readable medium of any one of examples 29 to 36, including or excluding optional features. In this example, the electronic device is a wireless mass storage device.

Example 38 is an apparatus for establishing Media Agnostic Universal Serial Bus (MA USB) communication with an electronic device. The apparatus includes means for receiving a data transfer request from an application to transmit data to the electronic device. The apparatus also includes means for establishing an MA USB traffic stream to the electronic device in response to the data transfer request. The MA USB traffic stream includes a plurality of Transmission Control Protocol (TCP) connections.

Example 39 includes the apparatus of example 38, including or excluding optional features. In this example, the application is executing on a multi-core processor, and the apparatus includes means for associating each TCP connection with a separate thread being executed on a separate core of the multi-core processor.

Example 40 includes the apparatus of any one of examples 38 to 39, including or excluding optional features. In this example, the electronic device initiates a separate receiving thread for each of the TCP connections.

Example 41 includes the apparatus of any one of examples 38 to 40, including or excluding optional features. In this example, the apparatus includes means for reordering MA USB packets received from the electronic device. Optionally, the means for reordering includes means for temporarily storing packets that are received out of order to a min-heap data structure.

Example 42 includes the apparatus of any one of examples 38 to 41, including or excluding optional features. In this example, the apparatus includes means for receiving parallel acknowledgements from the electronic device on each of the plurality of TCP connections.

Example 43 includes the apparatus of any one of examples 38 to 42, including or excluding optional features. In this example, the plurality of TCP connections include a first TCP connection and a second TCP connection, and the apparatus includes means for establishing the first TCP connection over a wired communication medium and establishing the second TCP connection over a wireless communication medium.

Example 44 includes the apparatus of any one of examples 38 to 43, including or excluding optional features. In this example, the plurality of TCP connections include a first TCP connection and a second TCP connection, and the apparatus includes means for establishing the first TCP connection over a WiFi network and establishing the second TCP connection over a cellular network.

Example 45 includes the apparatus of any one of examples 38 to 44, including or excluding optional features. In this example, each of the plurality of TCP connections is tied to a different antenna of a MIMO radio transceiver.

Example 46 includes the apparatus of any one of examples 38 to 45, including or excluding optional features. In this example, the electronic device is a wireless mass storage device.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for Media Agnostic Universal Serial Bus (MA USB) communication comprising:
a memory; and
processing circuitry coupled to the memory, wherein the processing circuitry is configured to:
receive a data transfer request from an application to transmit data to an electronic device: and
in response to the data transfer request, establish an MA USB traffic stream between the apparatus and the electronic device, wherein the MA USB traffic stream comprises a plurality of Transmission Control Protocol (TCP) connections.

2. The apparatus of claim 1, wherein the application is running on a multi-core processor, and each TCP connection corresponds with a separate thread executed on a separate core of the multi-core processor.

3. The apparatus of claim 1, wherein the electronic device initiates a separate receiving thread for each of the TCP connections.

4. The apparatus of claim 1, comprising an MA USB sequence reassembler to reorder MA USB packets received from the electronic device.

5. The apparatus of claim 4, wherein the MA USB sequence reassembler uses a min-heap data structure to temporarily store packets that are received out of order.

6. The apparatus of claim 1, wherein the processing circuitry is configured to receive parallel acknowledgements from the electronic device on each of the plurality of TCP connections.

7. The apparatus of claim 1, wherein the plurality of TCP connections comprise a first TCP connection and a second TCP connection, wherein the first TCP connection is established over a wired communication medium and the second TCP connection is established over a wireless communication medium.

8. The apparatus of claim 1, wherein the plurality of TCP connections comprise a first TCP connection and a second TCP connection, wherein the first TCP connection is established over a WiFi network and the second TCP connection is established over a cellular network.

9. The apparatus of claim 1, comprising a Multiple Input Multiple Output (MIMO) radio transceiver, wherein each of the plurality of TCP connections is tied to a different antenna of the MIMO radio transceiver.

10. The apparatus of claim 1, wherein the electronic device is a wireless mass storage device.

11. An integrated circuit package comprising one or more processors configured to establish Media Agnostic Universal Serial Bus (MA USB) communication with an electronic device, the one or more processors to:
receive a data transfer request from an application to transmit data to the electronic device; and
in response to the data transfer request, establish an MA USB traffic stream between the processor and the electronic device, wherein the MA USB traffic stream comprises a plurality of Transmission Control Protocol (TCP) connections.

12. The integrated circuit package of claim 11, wherein the application is executing on a multi-core processor, and each TCP connection corresponds with a separate thread executed on a separate core of the multi-core processor.

13. The integrated circuit package of claim 11, wherein the electronic device initiates a separate receiving thread for each of the TCP connections.

14. The integrated circuit package of claim 11, comprising an MA USB sequence reassembler to reorder MA USB packets received from the electronic device.

15. The integrated circuit package of claim 14, wherein the MA USB sequence reassembler uses a min-heap data structure to temporarily store packets that are received out of order.

16. The integrated circuit package of claim 11, wherein the integrated circuit package receives parallel acknowledgements from the electronic device on each of the plurality of TCP connections.

17. The integrated circuit package of claim 11, wherein the plurality of TCP connections comprise a first TCP connection and a second TCP connection, wherein the first TCP connection is established over a wired communication medium and the second TCP connection is established over a wireless communication medium.

18. The integrated circuit package of claim 11, wherein the plurality of TCP connections comprise a first TCP connection and a second TCP connection, wherein the first TCP connection is established over a WiFi network and the second TCP connection is established over a cellular network.

19. The integrated circuit package of claim 11, wherein each of the plurality of TCP connections is tied to a different antenna of a MIMO radio transceiver.

20. The integrated circuit package of claim 11, wherein the electronic device is a wireless mass storage device.

21. A method of establishing Media Agnostic Universal Serial Bus (MA USB) communication with an electronic device, the method comprising:
receiving a data transfer request from an application to transmit data to the electronic device; and
in response to the data transfer request, establishing an MA USB traffic stream to the electronic device, wherein the MA USB traffic stream comprises a plurality of Transmission Control Protocol (TCP) connections.

22. The method of claim 21, wherein the application is executing on a multi-core processor, the method comprising associating each TCP connection with a separate thread being executed on a separate core of the multi-core processor.

23. The method of claim 21, wherein the electronic device initiates a separate receiving thread for each of the TCP connections.

24. The method of claim 21, comprising reordering MA USB packets received from the electronic device.

25. The method of claim 21, temporarily storing packets that are received out of order to a min-heap data structure.
